(19) United States
(12) Patent Application Publication
(10) Pub. No.: US 2022/0307298 A1
(43) Pub. Date: Sep. 29, 2022

(54) VEHICLE LOCK DEVICE

(71) Applicant: Johnan Manufacturing Inc., Nagano (JP)

(72) Inventors: Naoki IDE, Nagano (JP); Mayu KOBAYASHI, Nagano (JP)

(73) Assignee: Johnan Manufacturing Inc., Nagano (JP)

(21) Appl. No.: 17/699,345

(22) Filed: Mar. 21, 2022

(30) Foreign Application Priority Data
Mar. 29, 2021 (JP) 2021-055978

(51) Int. Cl. E05B 83/24; E05B 15/04

(52) U.S. Cl. CPC E05B 83/243; E05B 15/04; E05B 2015/041

(57) ABSTRACT

A vehicle lock device includes a base including an entry groove for entry of a striker, a latch that is supported on the base and pivots between a restraining position to restrain the striker and a release position to release the striker, a locking lever that is supported on the base, engages the latch and holds the latch in the restraining position, and a torsion spring that is arranged adjacent to the latch so that a first arm portion is located on the latch side, and that presses the striker rearward in an entry direction when the first arm portion comes into contact with the striker. The first arm portion of the torsion spring is bent or curved in an axial direction of a coiled portion so that a tip portion of the first arm portion is located on an inner side of the coiled portion in the axial direction.

### CROSS-REFERENCE TO RELATED APPLICATION

The present patent application claims the priority of Japanese patent application No. 2021/055978 filed on Mar. 29, 2021, and the entire contents of Japanese patent application No. 2021/055978 are hereby incorporated by reference.

### TECHNICAL FIELD

The present invention relates to a vehicle lock device.

### BACKGROUND ART

One of known vehicle lock devices is, e.g., a vehicle lock device (a vehicle hood lock device) in which a torsion spring comes into direct contact with a striker and pushes the striker upward (see Patent Literature 1). This vehicle lock device includes a base (a base plate) having a striker groove for entry of a striker, a latch supported on the base so as to be rotatable between a latched position to lock the striker and an unlatched position, a locking lever (a locking plate) that has an engagement portion to be engaged with the latch located in the latched position and prevents the latch from rotating to the unlatched position, a first torsion spring that is arranged on a rotation axis of the latch, comes into contact with the striker and presses the striker, and a second torsion spring that is arranged on a rotation axis of the locking lever, comes into contact with the striker and presses the striker. In this vehicle lock device, arranging the torsion springs adjacently on the front side of the latch and the locking lever allows the size of the vehicle lock device to be reduced.

### CITATION LIST

### Patent Literature

Patent Literature 1: JP 2018-030482 A

### SUMMARY OF INVENTION

The known vehicle lock device described above has a problem that an arm portion of the torsion spring may get caught on the locking lever when the locking lever comes close to the arm portion of the torsion spring in a front-and-rear direction due to distortion (deformation) of the base caused by a load, etc., applied during use. If the arm portion of the torsion spring is caught on the locking lever, the striker S is not pushed up and down properly, and a hood closing operation and a hood opening operation are not performed properly.

It is an object of the invention to provide a vehicle lock device in which an arm portion of a torsion spring does not get caught on a locking lever even when the locking lever comes close to the arm portion of the torsion spring due to distortion, etc., of a base.

According to an aspect of the invention, provided is a vehicle lock device which is configured to lock a lid to open and close an opening of a vehicle into a closed state, the vehicle lock device comprising:
a base comprising an entry groove for entry of a striker;
a latch that is supported on the base and pivots between a restraining position to restrain the striker and a release position to release the striker;
a locking lever that is supported on the base, engages the latch and holds the latch in the restraining position; and
a torsion spring that is arranged adjacent to the latch so that a first arm portion is located on the latch side, and that presses the striker rearward in an entry direction when the first arm portion comes into contact with the striker,
wherein the first arm portion of the torsion spring is bent or curved in an axial direction of a coiled portion so that a tip portion of the first arm portion is located on an inner side of the coiled portion in the axial direction.

### Advantageous Effects of Invention

According to an aspect of the invention, a vehicle lock device can be provided in which an arm portion of a torsion spring does not get caught on a locking lever even when the locking lever comes close to the arm portion of the torsion spring due to distortion, etc., of a base.

### BRIEF DESCRIPTION OF DRAWINGS

FIG. 1A is a front view showing a vehicle lock device in an embodiment of the present invention when a hood is in an open state.

FIG. 1B is a front view when the hood is in a closed state.

FIG. 1C is a plan view when the hood is in the open state.

FIG. 2A is a front view showing a latch.

FIG. 2B is a side view when viewed from top right.

FIG. 2C is a perspective view.

FIG. 3A is a front view showing a torsion spring.

FIG. 3B is a plan view showing the torsion spring.

FIG. 3C is a plan view showing the vehicle lock device, in which illustration of the latch is omitted.

FIG. 4 is a front view showing the vehicle lock device when a first arm portion is pushed down by a striker.

FIGS. 5A-5C are explanatory diagrams showing the first half of a hood closing operation of the vehicle lock device.

FIGS. 6A-6B are explanatory diagrams showing the second half of the hood closing operation of the vehicle lock device.

FIGS. 7A-7C are explanatory diagrams showing a hood opening operation of the vehicle lock device.

FIG. 8A is a plan view showing a first modification of the vehicle lock device.

FIG. 8B is a front view showing the torsion spring in the first modification.

FIG. 8C is a plan view showing the torsion spring in the first modification.

FIG. 9A is a plan view showing a second modification of the vehicle lock device.

FIG. 9B is a front view showing the torsion spring in the second modification.

FIG. 9C is a plan view showing the torsion spring in the second modification.

### DESCRIPTION OF EMBODIMENTS

A vehicle lock device in an embodiment of the invention will be described below in reference to the appended drawings. This vehicle lock device is arranged at an opening of an engine compartment provided at the front of a vehicle and locks a hood (bonnet) (lid) opening/closing the opening in such a manner that the hood is locked in a closed state. The vehicle lock device has a locking function to lock the hood in the closed state by restraining a striker fixed to the hood, and a push-up function to push open the hood by pushing the striker up. Particularly, this vehicle lock device has a structure in which a first arm portion of a torsion spring does not get caught on a locking lever. In the following description, left, right, front, rear, up and down are as defined in each drawing. In particular, an entry direction of the striker is defined as an up-and-down direction, a direction orthogonal to the up-and-down direction is defined as a left-and-right direction, and a direction orthogonal to the up-and-down direction as well as the left-and-right direction is defined as a front-and-rear direction. In the present embodiment, for example, the up-and-down direction of the vehicle lock device coincides with an up-and-down direction of the vehicle, the left-and-right direction of the vehicle lock device coincides with a width direction of the vehicle, and the front-and-rear direction of the vehicle lock device coincides with a front-and-rear direction of the vehicle.

### Embodiment

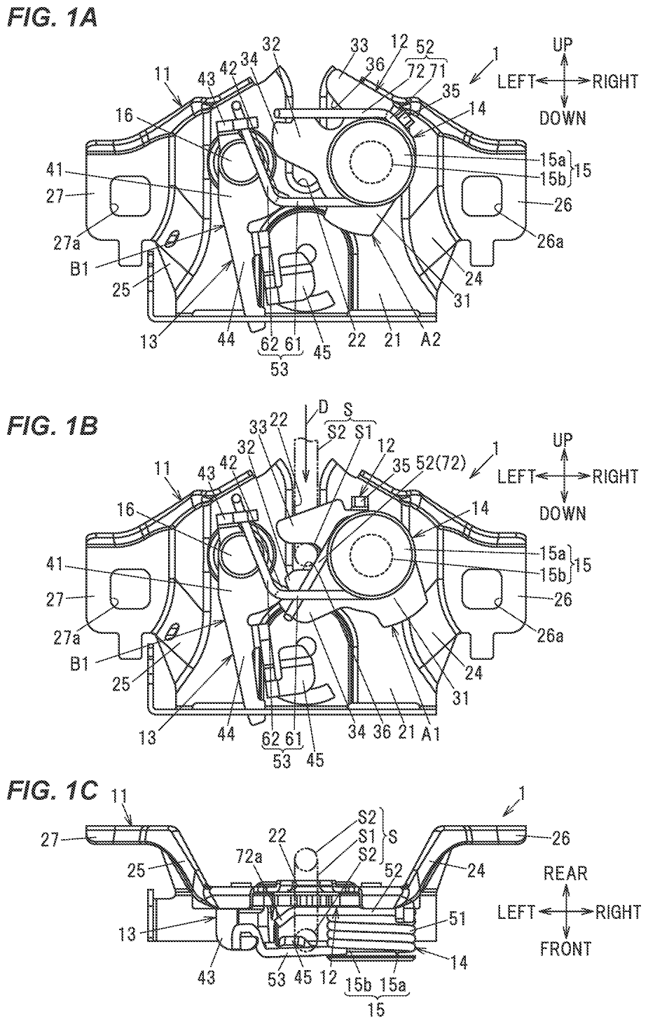

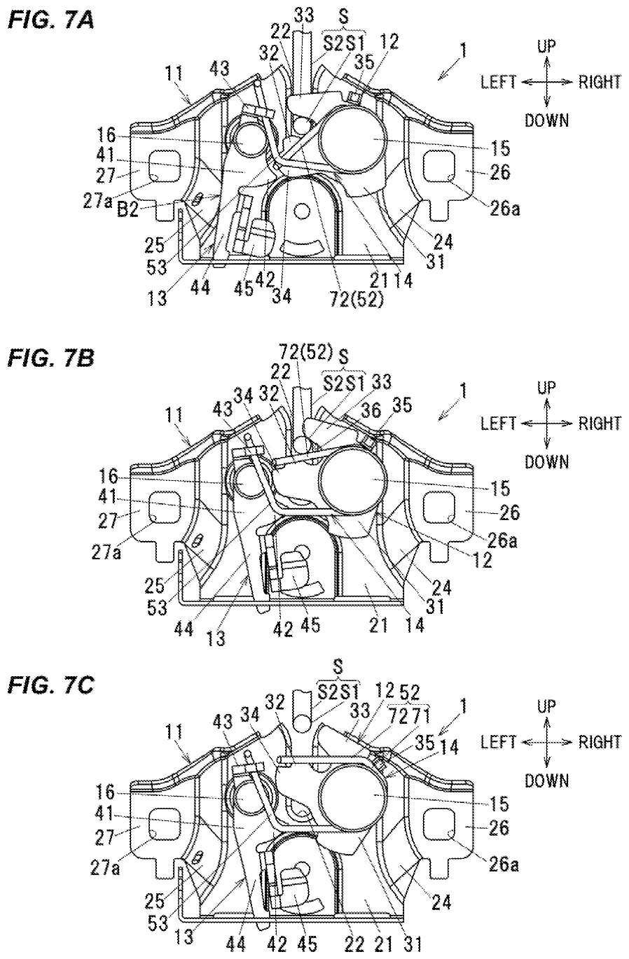

As shown in FIGS. 1A-1C, a vehicle lock device 1 includes a base 11 having an entry groove 22 for entry of a striker S, a hook-shaped latch 12 that is pivotably supported on a front surface of the base 11 on the right side and restrains the striker S, a locking lever 13 (pole) pivotably supported on the front surface of the base 11 on the left side to lock the latch 12, and a torsion spring 14 that is arranged adjacent to the latch 12 on the front side and pushes up the striker S rearward in an entry direction D. The latch 12 is supported on the base 11 by a latch pin 15 acting as a pivot axis so as to be able to pivot between a restraining position A1 (see FIG. 1B) to restrain the striker S and a release position A2 (see FIG. 1A) to release the striker S and also to allow entry of the striker S. Meanwhile, the locking lever 13 is supported on the base 11 by a locking pin 16 acting as a pivot axis so as to be able to pivot between a lock position B1 (see FIG. 1B) to lock the latch 12 at the restraining position A1 and an unlock position B2 (see FIG. 7A) to unlock the latch 12.

As shown in FIGS. 1A-1C, the base 11 is formed of a sheet metal and has a flat plate portion 21 having a plate shape, the entry groove 22 formed on the flat plate portion 21 at the middle in the left-and-right direction, a right rising portion 24 and a left rising portion 25 that rise up from left and right edges of the flat plate portion 21 so as to spread from each other toward the rear, a right flange portion 26 extending in the right direction from an end of the right rising portion 24 and having a right attachment hole 26a, and a left flange portion 27 extending in the left direction from an end of the left rising portion 25 and having a left attachment hole 27a. The base 11 is screwed to the vehicle body at two locations, the right attachment hole 26a and the left attachment hole 27a.

The entry groove 22 is an opening extending downward from an upper edge of the flat plate portion 21 and is formed as a “U”-shaped groove with an opening on the upper side and a bottom on the lower side in front view. The entry groove 22 has a width wide enough for the striker S to pass through and acts as a striker guide to guide the striker S. The striker S has a columnar engagement portion S1 and a pair of arm portions S2 supporting the columnar engagement portion S1 on both sides, and the entry groove 22 comes into contact with the columnar engagement portion S1 and guides the striker S.

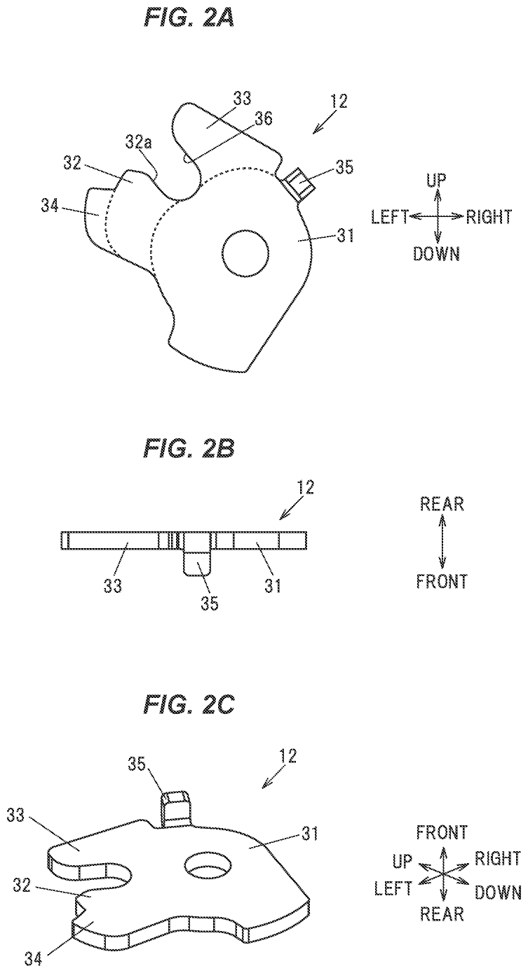

As shown in FIGS. 1A-1C and 2A-2C, the latch 12 is formed of a metal member having a plate shape and a “U”-shape, and integrally has a main body 31 pivotably attached to the latch pin 15, a first claw portion 32 extending in the left direction from the main body 31 so as to cross over the entry groove 22 and coming into contact with the striker S from below, a second claw portion 33 extending in the left direction from the main body 31 so as to face the first claw portion 32 and coming into contact with the columnar engagement portion S1 of the striker S from above, an engagement target claw 34 formed at an end of the first claw portion 32 and configured to be engaged with the locking lever 13, and an engagement target rib 35 (an engagement target portion) formed to rise forward from an upper right edge of the main body 31 and configured to be engaged with the torsion spring 14.

A restraining groove 36 to restrain the striker S is formed between the first claw portion 32 and the second claw portion 33. In the state in which the latch 12 is pivoted and located in the restraining position A1, the restraining groove 36 faces to left. In the state in which the latch 12 is pivoted and located in the release position A2, the open side of the restraining groove 36 faces upward to allow the striker S moving on the entry groove 22 to enter the inside of the restraining groove 36.

The first claw portion 32 has an upper end face 32a serving as a contact surface (a receiving surface) coming into contact with the columnar engagement portion S1 of the striker S, and acts as a pressure receiving portion that receives pressure from the striker S moving on the entry groove 22 from above. Meanwhile, the second claw portion 33 has a lower end face serving as a pressing surface to press the columnar engagement portion S1 of the striker S from above, and acts as a pressing portion to restrict the striker S from moving rearward in the entry direction D (see FIG. 1B) and hold the striker S in the state in which the latch 12 is pivoted and located in the restraining position A1.

The engagement target rib 35 is a rib formed to rise from the main body 31 toward the front and comes into contact with and engages a first arm portion 52 of the torsion spring 14 from diagonally right above. The engagement target rib 35 engage the first arm portion 52 from the rear side of a winding direction of the torsion spring 14 (i.e., from a clockwise side in the circumferential direction of the torsion spring 14 in the front view) and transmits a pressing force of the torsion spring 14 to the latch 12. The latch 12 is pressed toward the release position A2 by this pressing force of the torsion spring 14. It can be also described that the engagement target rib 35 comes into contact with and engages the first arm portion 52 at the rear side of the rotation direction of the first arm portion 52 when the striker S pushes down the first arm portion 52. This configuration allows the engagement target rib 35 to be disengaged from the first arm portion 52 when the striker S pushes down the first arm portion 52 in the entry direction D. The details of this configuration will be described later.

As shown in FIGS. 1A-1C, the locking lever 13 is formed of a plate-shaped metal member extending in the up-and-down direction, and integrally has a main body 41 pivotably supported about the locking pin 16 and extending in the up-and-down direction, an engagement claw 42 (an engagement portion) formed at a lower end of the main body 41 on the right side and configured to engage the engagement target claw 34 of the latch 12, a spring engagement portion 43 formed at an upper end of the main body 41 and engaging a second arm portion 53 of the torsion spring 14, a downward extension portion 44 extending downward from a lower end of the main body 41, and an operation portion 45 formed at a base end of the downward extension portion 44 on the right side and operated by a release cable (not shown).

In the state in which the locking lever 13 is pivoted and located in the lock position B1, the engagement claw 42 engages the engagement target claw 34 of the latch 12 pivoted and located in the restraining position A1, and locks (holds) the latch 12 in the restraining position A1. Meanwhile, in the state in which the locking lever 13 is pivoted and located in the unlock position B2, the engagement target claw 34 is disengaged from the engagement claw 42 and the latch 12 is unlocked. Pivoting from the lock position B1 to the unlock position B2 is performed by operating the operation portion 45 using the release cable. Meanwhile, in the state in which operation by the release cable is not performed, the pressing force of the torsion spring 14 is transmitted to the locking lever 13 via the second arm portion 53 and the locking lever 13 is pivoted and located in the lock position B1. An upper end face of the engagement claw 42 is a guide slope inclined downward to the right. When the latch 12 pivots from the release position A2 to the restraining position A1 in a state in which the locking lever 13 is located in the lock position B1, this guide slope comes into contact with the latch 12 and the locking lever 13 pivots toward the unlock position B2. This allows the latch 12 to pivot to the restraining position A1.

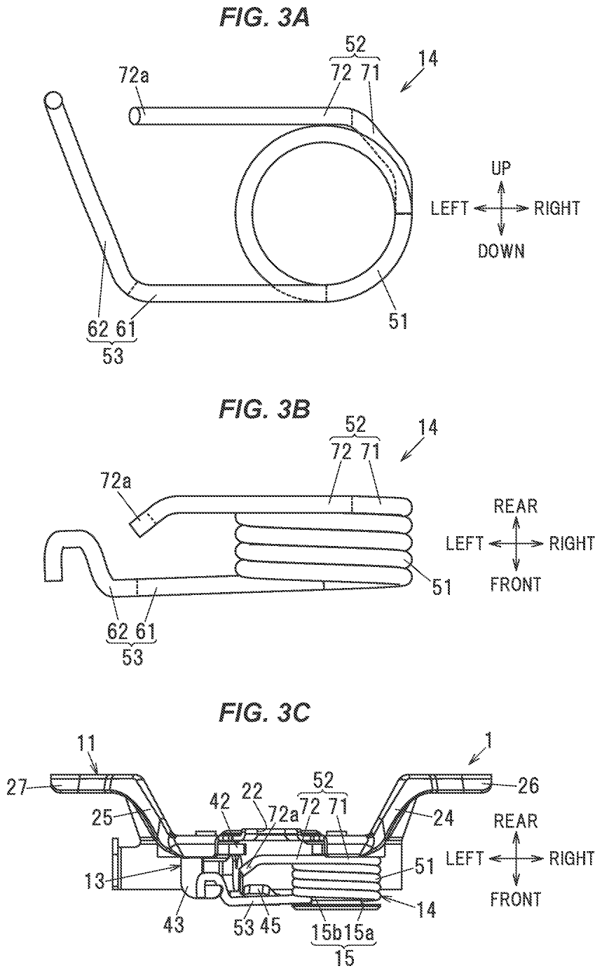

As shown in FIGS. 1A-1C and 3A-3C, the torsion spring 14 is wound on the latch pin 15 and has a coiled portion 51 formed by winding a metal wire, the first arm portion 52 located on the rear side and formed by extending the metal wire from one end of the coiled portion 51, and the second arm portion 53 located on the front side and formed by extending the metal wire from the other end of the coiled portion 51. In particular, the torsion spring 14 is arranged between a head portion 15a of the latch pin 15 and the latch 12 with a shaft portion 15b of the latch pin 15 inserted therethrough and is adjacently arranged on the front side of the latch 12 so that the first arm portion 52 is located on the latch 12 side.

The second arm portion 53 has a left extension portion 61 extending in the left direction from a lower portion of the coiled portion 51, and a lever engagement portion 62 that is bent from an end of the left extension portion 61, extends diagonally upward to the left and engages the spring engagement portion 43 of the locking lever 13. The torsion spring 14 presses the locking lever 13 toward the lock position B1 through this engagement between the lever engagement portion 62 of the second arm portion 53 and the spring engagement portion 43 of the locking lever 13.

The first arm portion 52 has a latch engagement portion 71 that extends upward from a right portion of the coiled portion 51 and then diagonally upward to the left and engages the engagement target rib 35 of the latch 12, and a striker contact portion 72 that is connected to an end of the latch engagement portion 71, extends to the left over the entry groove 22 and is configured to come into contact with the striker S. The torsion spring 14 applies an elastic force to the latch 12 toward the release position A2 through this engagement between the latch engagement portion 71 of the first arm portion 52 and the engagement target rib 35 of the latch 12. The torsion spring 14 also presses the striker S rearward (upward) in the entry direction D by the striker contact portion 72 of the first arm portion 52 which is in press contact with the columnar engagement portion 51 of the striker S.

The first arm portion 52 is also configured such that when it is pushed down (in the entry direction D of the striker S) by the striker S, the latch engagement portion 71 is disengaged from the engagement target rib 35. That is, in the state in which the first arm portion 52 is pushed down by the striker S, the latch engagement portion 71 is disengaged from the engagement target rib 35, and the torsion spring 14 presses only the striker S, of the striker S and the latch 12. Meanwhile, in the state in which the hood (not shown) is open and the first arm portion 52 is not pushed down by the striker S, the latch engagement portion 71 of the torsion spring 14 engages the engagement target rib 35 and presses the latch 12. That is, the latch engagement portion 71 engages the engagement target rib 35 and presses the latch 12 in the state in which the first arm portion 52 is not pushed down by the striker S, regardless of whether or not the striker S is in contact with the first arm portion 52.

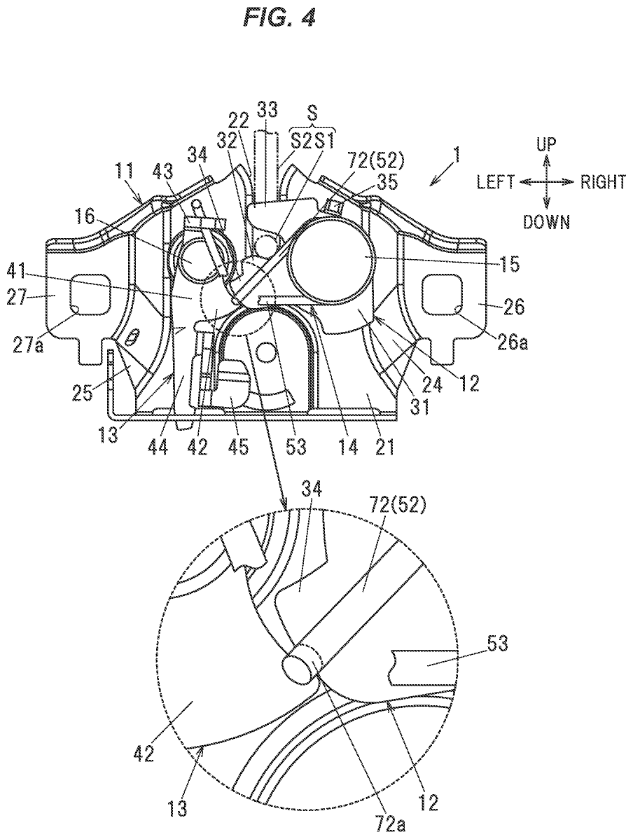

As shown in FIGS. 3A and 3C, the striker contact portion 72 is bent forward on the tip side. In particular, as shown in FIG. 3C, in the state in which the first arm portion 52 is not pushed down by the striker S, the striker contact portion 72 extends straight in the left direction until a position beyond the entry groove 22 and is then bent forward (inward in the axial direction of the coiled portion 51). In more particular, the striker contact portion 72 is bent forward so that a predetermined tip portion 72a is located on the inner side of the coiled portion 51 in the axial direction of the coiled portion 51. Thus, the striker contact portion 72 is bent to the side away from the engagement claw 42 so that the predetermined tip portion 72a is at a distance from the engagement claw 42 of the locking lever 13 in the front-and-rear direction. As shown in FIG. 4, the predetermined tip portion 72a located inward in the axial direction of the coiled portion 51 is a portion overlapping the locking lever 13 as viewed in the front-and-rear direction (the axial direction of the coiled portion 51) when the first arm portion 52 is pushed down by the striker S. That is, the striker contact portion 72 is bent forward so that a portion overlapping the locking lever 13 as viewed in the front-and-rear direction when the first arm portion 52 is pushed down by the striker S is located on the inner side of the coiled portion 51 in the axial direction of the coiled portion 51.

### (Operation of the Vehicle Lock Device)

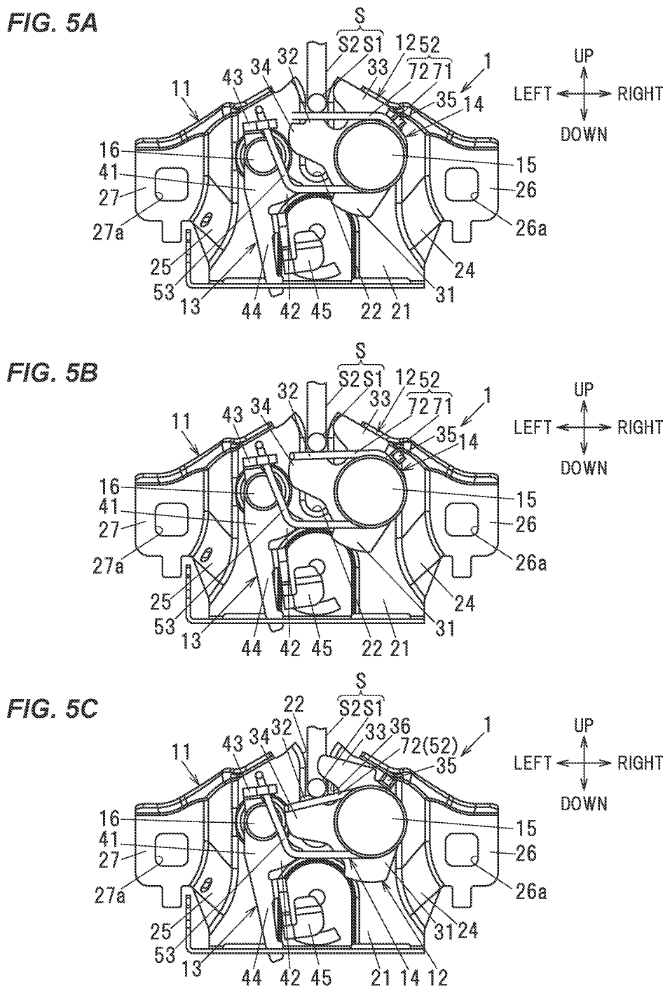

Next, a hood closing operation (a hood closing method) and a hood opening operation (a hood opening method) of the vehicle lock device 1 will be described in reference to FIGS. 5A to 7C. The arm portion S2 of the striker S which is located on the front side of the drawing is omitted in FIGS. SA to 7C.

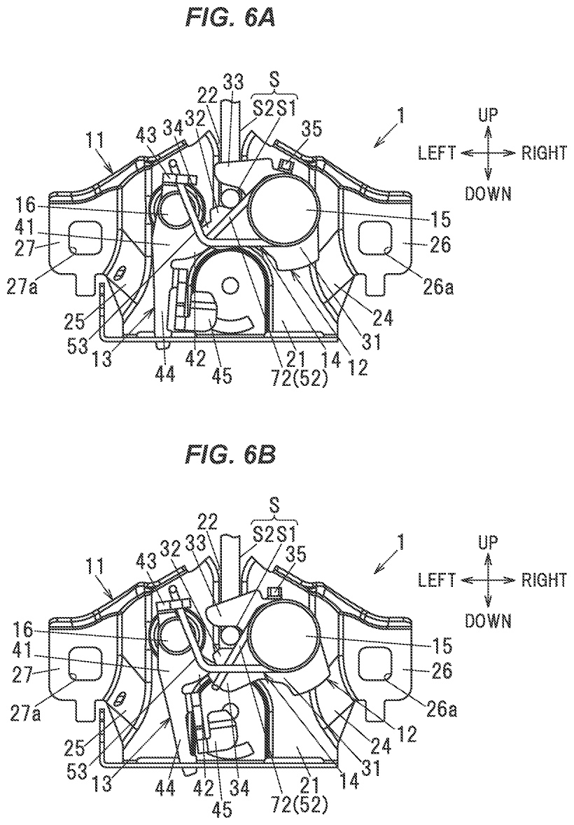

Firstly, the hood closing operation of the vehicle lock device 1 will be described in reference to FIGS. 5A-5C and 6A-6B. This hood closing operation is performed by a user dropping a front-end side of the hood from above and is an operation to restrain the striker S of the closed hood by the vehicle lock device 1 and thereby lock (hold) the hood in the closed state. In addition, the hood closing operation is started in the state in which the latch 12 is pivoted and located in the release position A2 by the pressing force of the torsion spring 14 and the locking lever 13 is pivoted and located in the lock position B1. In this regard, in the state before the hood closing operation is performed (in the state in which the latch 12 is at a distance from the striker S), the first arm portion 52 of the torsion spring 14 engages the engagement target rib 35 of the latch 12 and the latch 12 is pressed to the release position A2.

As shown in FIG. 5A, when closure of the hood is started by dropping the front side of the hood, the striker S firstly enters the entry groove 22 and the columnar engagement portion S1 of the striker S comes into contact with (the striker contact portion 72 of) the first arm portion 52 of the torsion spring 14. Since the first arm portion 52 of the torsion spring 14 is arranged above the first claw portion 32 of the latch 12, the columnar engagement portion S1 of the striker S firstly comes into contact with the first arm portion 52.

Then, when the closure of the hood proceeds and the striker S advances on the entry groove 22, the first arm portion 52 is pressed down by the striker S and rotates downward and the latch engagement portion 71 of the first arm portion 52 is disengaged from the engagement target rib 35 of the latch 12 by the rotation of the first arm portion 52 as shown in FIG. 5B. After that, the striker S comes into contact with the first claw portion 32 of the latch 12.

Then, when the closure of the hood further proceeds and the striker S continues to advance on the entry groove 22, the first arm portion 52 is more rotated as shown in FIG. 5C and also the latch 12 pivots toward the restraining position A1 by pressure from the striker S. This causes the columnar engagement portion S1 of the striker S to enter the restraining groove 36 of the latch 12. After that, when the closure of the hood further proceeds and the latch 12 reaches the restraining position A1 as shown in FIG. 6A, the engagement target claw 34 of the latch 12 engages the engagement claw 42 of the locking lever 13 and the latch 12 is locked in the restraining position A1. The latch 12 locked in the restraining position A1 restrains the striker S, hence, the hood having the striker S fixed thereto is locked in the closed state.

After that, the first arm portion 52 of the torsion spring 14 presses the columnar engagement portion S1 of the striker S against the second claw portion 33 of the latch 12, as shown in FIG. 6B. In this way, the torsion spring 14 acts as a buffer that presses the striker S against the second claw portion 33. The hood closing operation is thereby completed.

Next, the hood opening operation of the vehicle lock device 1 will be described in reference to FIGS. 7A-7C. This hood opening operation is performed by a user operating the operation portion 45 with the release cable and is an operation to push up the striker S by the vehicle lock device 1 and push open the hood. The hood opening operation is started in the state shown in FIG. 6B in which the latch 12 is locked in the restraining position A1 by the locking lever 13 and the latch 12 locked in the restraining position A1 restrains the striker S.

When the user operates the operation portion 45 by using the release cable, the locking lever 13 pivots from the lock position B1 to the unlock position B2 as shown in FIG. 7A and unlocks the latch 12. When the latch 12 is unlocked, the striker S is pushed upward by the first arm portion 52 due to the pressing force of the torsion spring 14, and the latch 12 of which second claw portion 33 is in contact with the columnar engagement portion S1 of the striker S pivots toward the release position A2.

Then, after the latch 12 pivots due to pushing up of the striker S so that the restraining groove 36 faces upward as shown in FIG. 7B, the columnar engagement portion S1 of the striker S comes out of the restraining groove 36. Once the columnar engagement portion S1 of the striker S comes out of the restraining groove 36, the striker S is thrown up by the pressing force of the torsion spring 14 as shown in FIG. 7C and the hood is push opened. At this time, the first arm portion 52 of the torsion spring 14 returns to the state before being pushed down, and (the latch engagement portion 71 of) the first arm portion 52 engages the engagement target rib 35 of the latch 12. Due to this engagement, the latch 12 is pressed toward the release position A2 by the pressing force of the torsion spring 14 and the position of the latch 12 is kept in the release position A2. The hood opening operation is thereby completed.

### (Functions and Effects of the Embodiment)

In the configuration of the embodiment described above, since the first arm portion 52 of the torsion spring 14 is bent or curved forward so that the tip portion 72a of the first arm portion 52 is located on the inner side of the coiled portion 51 in the axial direction of the coiled portion 51, the first arm portion 52 of the torsion spring 14 does not get caught on the locking lever 13 even when the locking lever 13 comes close to the first arm portion 52 due to distortion, etc., of the base 11.

That is, in the vehicle lock device 1, the torsion spring 14 is arranged adjacent to the latch 12 so that the first arm portion 52 is located on the latch 12 side and the size of the vehicle lock device 1 in the front-and-rear direction is thereby reduced. Meanwhile, in some cases, the base 11 is distorted (deformed) by a load, etc., during when using the vehicle lock device 1, and this results in that the engagement claw 42 of the locking lever 13 comes close to the first arm portion 52 in the front-and-rear direction. In the conventional vehicle lock device 1, these cause a problem that the first arm portion, which is pushed down by the striker and rotates, gets caught on the engagement claw of the locking lever that came close to the first arm portion in the front-and-rear direction. If the engagement claw is caught on the first arm portion, the striker is not pushed up and down properly, and the hood closing operation and the hood opening operation are not performed properly. In contrast to this, in the configuration of the present embodiment, since the first arm portion 52 of the torsion spring 14 is bent or curved forward so that the tip portion 72a of the first arm portion 52 is located on the inner side of the coiled portion 51 in the axial direction of the coiled portion 51, the tip portion 72a of the first arm portion 52 can be located at a distance from the engagement claw 42 of the locking lever 13 without change in the position of the torsion spring 14. As a result, even if the engagement claw 42 of the locking lever 13 comes close to the first arm portion 52 due to distortion, etc., of the base 11, the engagement claw 42 of the locking lever 13 does not get caught on the first arm portion 52 pushed down by the striker S (getting caught can be suppressed) while keeping a small size of the vehicle lock device 1 in the front-and-rear direction. Thus, it is possible to avoid such an event that the striker S is not pushed up and down properly and the hood closing operation and the hood opening operation are not performed properly. Although the case where the engagement claw 42 of the locking lever 13 comes close to the first arm portion 52 in the front-and-rear direction due to distortion of the base 11 has been described here as an example, the engagement claw 42 of the locking lever 13 could come close to the first arm portion 52 in the front-and-rear direction due to a manufacturing error, etc.

In addition, in the configuration of the embodiment described above, since the torsion spring 14 is arranged adjacent to the latch 12 so that the first arm portion 52 is located on the latch 12 side, the front surface of the latch 12 acts as a guide surface to guide the first arm portion 52 and it is thereby possible to suppress violent movement of the first arm portion 52 in the front-and-rear direction.

### Other Embodiments

Although the embodiment of the invention has been described, the invention according to claims is not to be limited to the embodiment. Further, please note that not all combinations of the features described in the embodiment are necessary to solve the problem of the invention. The invention can be appropriately modified and implemented without departing from the gist thereof.

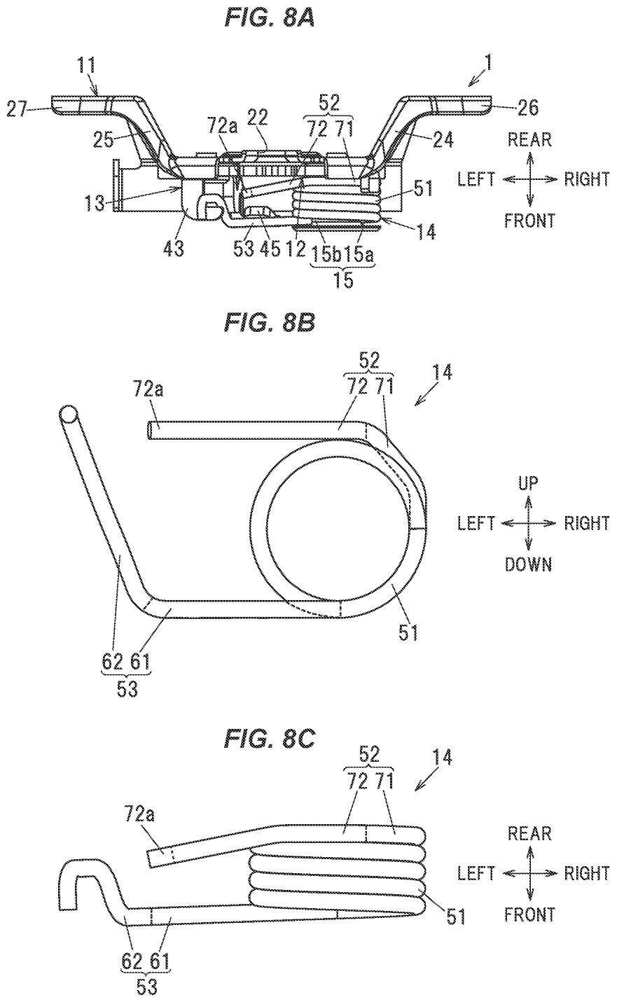

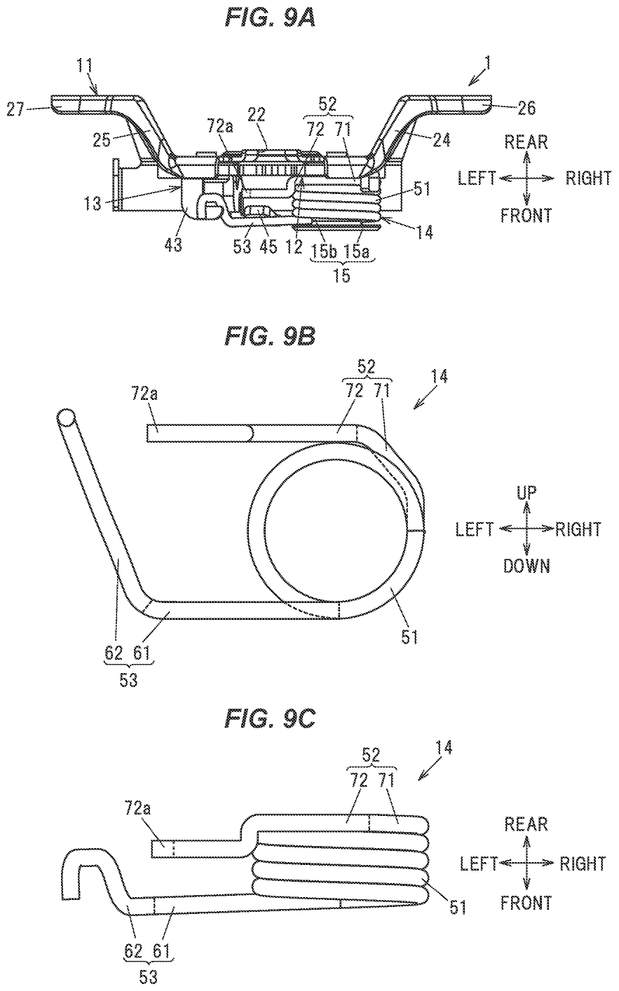

For example, (the striker contact portion 72 of) the first arm portion 52 is bent forward after crossing the entry groove 22 in the configuration of the embodiment described above, it is not limited thereto as long as the first arm portion 52 is bent or curved forward so that the tip portion 72a of the first arm portion 52 is located on the inner side of the coiled portion 51 in the axial direction of the coiled portion 51. That is, a forward bend may be formed at a position just before the entry groove 22 as shown in FIGS. 8A-8C, or (the striker contact portion 72 of) the first arm portion 52 may be bent forward into an “L”-shape as shown in FIGS. 9A-9C. Furthermore, the first arm portion 52 may be curved rather than bent, or the first arm portion 52 may have a combination of curve and bend so that the tip portion 72a of the first arm portion 52 is located on the inner side of the coiled portion 51 in the axial direction of the coiled portion 51.

In addition, although the invention is applied to the vehicle lock device 1 used to lock the hood for engine compartment (the engine hood) in the closed state in the embodiment described above, it is not limited thereto, and the invention may be applied to a vehicle lock device used to lock a hood for trunk compartment (a trunk hood) in the closed state. Furthermore, the invention is applicable to any vehicle lock device as long as it locks a lid opening/closing an opening provided on a vehicle body in such a manner that the lid is locked in a closed state, and the invention may be applied to, e.g., a vehicle lock device used to lock a lid opening/closing a charging port (so-called charging port lid) in the closed state.

In addition, although the striker S is fixed on the hood (lid) side and the vehicle lock device 1 is fixed on the opening side in the configuration of the embodiment described above, the configuration may such that the vehicle lock device 1 is fixed on the hood (lid) side and the striker S is fixed on the opening side.

In addition, although the description is omitted in the embodiment described above, the vehicle lock device 1 may further includes a safety lever to stop the hood in such a manner that the hood, which is going to open, is stopped in a partially open state in which the hood is slightly opened. In such a case, the expressions about the hood, such as open, at the time of opening and the open state in the embodiment described above include partially open, at the time of partially opening and the partially open state of the hood.

### REFERENCE SIGNS LIST

1 VEHICLE LOCK DEVICE
11 BASE
12 LATCH
13 LOCKING LEVER
14 TORSION SPRING
22 ENTRY GROOVE
51 COILED PORTION
52 FIRST ARM PORTION
72a TIP PORTION
A1 RESTRAINING POSITION
A2 RELEASE POSITION
D ENTRY DIRECTION
S STRIKER

1. A vehicle lock device which is configured to lock a lid to open and close an opening of a vehicle into a closed state, the vehicle lock device comprising:
a base comprising an entry groove for entry of a striker;
a latch that is supported on the base and pivots between a restraining position to restrain the striker and a release position to release the striker;
a locking lever that is supported on the base, engages the latch and holds the latch in the restraining position; and
a torsion spring that is arranged adjacent to the latch so that a first arm portion is located on the latch side, and that presses the striker rearward in an entry direction when the first arm portion comes into contact with the striker,
wherein the first arm portion of the torsion spring is bent or curved in an axial direction of a coiled portion so that a tip portion of the first arm portion is located on an inner side of the coiled portion in the axial direction.

2. The vehicle lock device according to claim 1, wherein the tip portion is a portion overlapping the locking lever as viewed in the axial direction when the first arm portion is pushed down by the striker.
